(19) United States
(12) Patent Application Publication
(10) Pub. No.: US 2010/0152988 A1
(43) Pub. Date: Jun. 17, 2010

(54) ACCELERATOR BRAKING MODULE

(76) Inventor: Erland George Olofsson, North Rocks (AU)

Correspondence Address: MASUVALLEY & PARTNERS, 8765 AERO DRIVE, SUITE 312, SAN DIEGO, CA, 92123, US

(21) Appl. No.: 12/733,249

(22) PCT Filed: Aug. 21, 2008
(86) PCT No.: PCT/AU2008/001213

§ 371 Date: Feb. 19, 2010

(30) Foreign Application Priority Data
Aug. 21, 2007 (AU) 2007904505
Oct. 31, 2007 (AU) 2007231765

(51) Int. Cl. G06F 19/00; B60W 10/18

(52) U.S. Cl. 701/70

(57) ABSTRACT

An accelerator braking system for a vehicle; said braking system reactive to forces applied to an accelerator pedal of said vehicle; said system characterized by a transmission to a control module of data corresponding to said forces applied to said accelerator pedal wherein braking force is gradually increased and decreased by operation of the accelerator pedal. In a preferred form the braking system is reactive to forces applied to a secondary reaction surface of an accelerator pedal of said vehicle; said system characterized by a transmission to a control module of force data or angle data wherein braking force is gradually increased and decreased by operation of the accelerator pedal.

The present invention relates to control systems for motor vehicles and, more particularly to the interaction of acceleration and braking of a vehicle and even more particularly to a modular electronic device for implementing same.

### BACKGROUND

It is well known that the distance required to bring a moving vehicle to a standstill from the instant a driver perceives a potentially hazardous situation to the vehicle coming to rest, is a combination of the reaction distance and the braking distance.

The reaction distance is that distance covered during the delay between which the mind of the driver perceives the situation and decides to act, to the actual activating of the vehicles braking system. The braking distance is that distance actually required to bring the vehicle to a standstill from the speed at which it was travelling under the application of the optimum braking force.

Both the reaction distance and the braking distance are clearly functions of the initial speed of the vehicle, while the braking distance is additionally affected by road and weather conditions as well as the efficiency of the braking system.

Improvements in braking systems have significantly reduced the braking distance in emergency situations, while the reaction distance has tended to remain relatively stable. A disadvantage in conventional vehicle control systems in an emergency situation is that the reaction distance is partly made up of the time taken to physically lift the driver's foot from the accelerator pedal, transfer it to the brake pedal and depress that pedal.

Conventional control systems also are inconvenient in non-emergency braking situations. For example in “stop start” traffic situations, the need to repeatedly transfer the driver's foot from one pedal to the other can become very tiring.

The applicant's earlier filed International Patent Application number PCT/AU01/00582 and prior art U.S. Pat. No. 3,082,851 to Sheriff disclose substantially mechanical arrangements. However such arrangements are prone to failure and are difficult to calibrate. They can also be difficult to retrofit. They can also be difficult to customise “on the fly” to suit the preferences of the individual driver.

It is an object of the present invention to address or ameliorate some of the above disadvantages.

### Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### Definitions

In this specification the following terms are to have the meanings as defined here:

“Secondary reaction surface” means a surface interposed between at least a portion of the accelerator pedal of a vehicle and another surface against which it reacts. In one instance the surface against which the secondary reaction surface reacts may be that of a foot applied to the accelerator pedal. In other instances other surfaces can be utilised.

### BRIEF DESCRIPTION OF INVENTION

Accordingly in one broad form of the invention, there is provided an accelerator braking system for a vehicle; said braking system reactive to forces applied to a secondary reaction surface of an accelerator pedal of said vehicle; said system characterized by a transmission to a control module of data corresponding to said forces applied to said secondary reaction surface wherein braking force is gradually increased and decreased by operation of the accelerator pedal.

In another broad form of the invention, there is provided an accelerator braking system for a vehicle; said braking system reactive to forces applied to a secondary reaction surface of an accelerator pedal of said vehicle; said system characterized by a transmission to a control module of force data or angle data wherein braking force is gradually increased and decreased by operation of the accelerator pedal.

Preferably, said control module includes a servomotor acting on said braking system.

Preferably, said servomotor acts on a brake pedal of said braking system.

Preferably, said servomotor is connected to a portion of a pedal arm of said brake pedal by means of a flexible coupling.

Preferably, said secondary reaction surface comprises a pressure sensitive mat covering at least a portion of said accelerator pedal; said pressure sensitive mat reactive to pressure applied by a foot of a driver between a first deactivated state and a second fully activated state of said pressure sensitive mat.

Preferably, said pressure sensitive mat includes a load cell in electronic communication with said control module.

Preferably, said secondary reaction surface comprises a hinged auxiliary pedal attached to said accelerator pedal; said hinged auxiliary pedal arranged for movement from a first deactivated state to a second fully activated state by pressure applied by a foot of a driver.

Preferably, said hinged auxiliary pedal includes a sensor in electronic communication with said control module.

Preferably, in said fully activated state, additional pressure applied by said foot of said driver is transferred to said accelerator pedal so as to urge said accelerator pedal into an activated position.

Preferably, pressure applied by said foot of a driver to urge said secondary reaction surface from said deactivated state to said fully activated state is less than pressure required to urge said accelerator pedal from a deactivated state into a said activated position.

Preferably, transition from said fully activated state of said secondary reaction surface to a said activated position of said accelerator pedal includes a neutral feel zone perceptible to said driver.

Preferably, an indicator light mounted in view of a said driver of said vehicle is activated when pressure applied to said accelerator pedal is in said neutral feel zone.

Preferably, a transition from a said inactive state to a said fully activated state of said secondary reaction surface, is accompanied by a transition of said braking system from at least a percentage of full braking force to a zero braking force.

Preferably, said accelerator braking system is enabled by a suitably mounted enable switch within reach of a driver of said vehicle.

Preferably, said enable switch is illuminated when and only when the system is enabled.

Preferably, said brake pedal is provided with a secondary reaction surface; said secondary reaction surface comprising a pressure sensitive pad incorporating a disable switch, whereby pressure applied to said secondary reaction surface operates said switch to deactivate said control module.

Preferably, a range of said braking force between said zero braking force and said at least a percentage of full braking force (up to 100% of braking force) is adjustable from a dial control mounted within reach of a said driver of said vehicle.

Preferably, rate of response of said control module to said transmission of force data between said zero braking force and said at least a percentage of full braking force is adjustable from a dial control mounted within reach of a said driver of said vehicle.

Preferably, said system is turned off when a foot is placed on said brake pedal.

Preferably, an “on” switch is available to switch the system on.

Preferably, said switch is illuminated when said system is on.

Preferably, a “coasting light” is illuminated when said accelerator pedal is in said neutral feel zone.

In another broad form of the invention, there is provided a method of reducing reaction time between a perceived need to brake a vehicle and application of the brakes of said vehicle; said method including the steps of:
(a) providing a secondary reaction surface to an accelerator pedal of a said vehicle,
(b) electronically linking said secondary reaction surface with a control module acting on a brake pedal of said vehicle.

Preferably, said secondary reaction surface is operable between an inactivated state and a fully activated state.

Preferably, said control module activates said brakes of said vehicle between at least a percentage of full braking force and zero braking force, as force applied to said secondary reaction force varies between zero and a maximum.

In another broad form of the invention, there is provided a method of braking a vehicle by means of interaction between a secondary reaction surface applied to an accelerator pedal, and a control module; said control module acting on a brake pedal of said vehicle; said method including the steps of:
(a) arranging said secondary reaction surface to respond to pressure from a driver of said vehicle between a first deactivated state and a fully activated state,
(b) arranging said control module to act on a brake pedal of said vehicle, between applying at least a percentage of full braking force and a zero braking force as said secondary reaction surface responds between said first deactivated state and said fully activated state.

In another broad form of the invention, there is provided a method of urging a vehicle into motion by means of operation of an accelerator pedal of said vehicle; said method including the steps of:
(a) applying a first increasing pressure to a secondary reaction surface of said accelerator pedal,
(b) increasing said first increasing pressure to a maximum reaction point of said reaction surface so as to disengage a braking system of said vehicle,
(c) applying a second increasing pressure to said secondary reaction surface so as to urge said accelerator pedal into a depressed state,
   whereby the state of said vehicle is changed from a braked standstill to a state of motion.

In another broad form of the invention, there is provided a method of bringing a vehicle to a standstill by means of operation of an accelerator pedal of said vehicle; said method including the steps of:
(a) applying a first decreasing pressure to a secondary reaction surface of said accelerator pedal in a depressed state,
(b) decreasing said first decreasing pressure to a point at which said accelerator pedal is fully retracted from said depressed state,
(c) applying a second decreasing pressure to said secondary reaction surface,
(d) decreasing said second decreasing pressure to a point where there is no pressure applied to said secondary reactions surface,
   whereby the state of said vehicle is changed from one in motion to a state of braked standstill.

In a further broad form of the invention there is provided an accelerator braking system for a vehicle; said braking system reactive to forces applied to an accelerator pedal of said vehicle; said system characterized by a transmission to a control module of data corresponding to said forces applied to said accelerator pedal wherein braking force is gradually increased and decreased by operation of the accelerator pedal.

Preferably said braking force is a function of the forces applied to said accelerator pedal at least over a portion of the range of forces applied to said accelerator pedal.

In yet a further broad form of the invention, there is provided an accelerator braking system for a vehicle; said braking system reactive to forces applied to an accelerator pedal of said vehicle; said system characterized by a transmission to a control module of force data or angle data wherein braking force is gradually increased and decreased by operation of the accelerator pedal.

Preferably said braking force is applied is a function of the forces applied to said accelerator pedal at least over a portion of the range of forces applied to said accelerator pedal.

Preferably force is applied via a secondary reaction surface associated with said accelerator pedal.

Preferably said secondary reaction surface is interposed between the foot of an operator and said accelerator pedal.

Preferably said secondary reaction surface is interposed between said accelerator pedal and an actuator surface.

Preferably said system further includes an accelerator pedal transducer associated with said accelerator pedal and wherein data is transmitted from said transducer to said control module.

Preferably said system includes a brake pedal transducer associated with said a brake pedal of said vehicle and wherein data is transmitted from said brake pedal transducer to said control module.

Preferably said control module comprises an engine control module of said vehicle; said engine control module controlling operation of the engine and related components of said vehicle.

### BRIEF DESCRIPTION OF DRAWINGS

Embodiments of the present invention will now be described with reference to the accompanying drawings wherein:

FIG. 1 (Prior Art) is an illustration of the two components, reaction distance and braking distance at various speeds which determine the overall distance required to bring a vehicle to a standstill from a first perceived need by a driver to do so,

FIG. 2 comprises prior art disclosure from applicant's earlier filed International Patent Application no PCT/AU01/00582 illustrating preferred braking characteristics to be imparted as part of accelerator pedal operation;

FIG. 3 is a general schematic of the accelerator and brake pedal controls of a vehicle fitted with the accelerator brake system of the present invention,

FIG. 4 is a schematic of a secondary reactive surface attached to an accelerator pedal according to a first preferred embodiment of the accelerator brake system of the invention,

FIG. 5 is a schematic of a secondary reactive surface attached to an accelerator pedal according to a second preferred embodiment of the accelerator brake system of the invention,

FIG. 5A is a schematic of a secondary reactive surface attached to an accelerator pedal according to a third preferred embodiment of the accelerator break system of the invention and

FIG. 5B is a schematic of a secondary reactive surface attached to an accelerator pedal according to a fourth preferred embodiment of the accelerator break system of the invention

FIG. 6 is a brake pedal module, in accordance with a first preferred embodiment of the present invention,

FIG. 7 is a graph representing the interaction of the accelerator pedal, brake pedal and braking force of the accelerator brake system of FIGS. 3 to 6.

FIG. 8 is a lay out of an installation of at least a preferred embodiment of the present invention in the cabin of a vehicle.

FIG. 9 is a block diagram of an electronic implementation of the modular arrangement of FIG. 8.

FIG. 10 is a block diagram of a “factory fit” embodiment of the electronic implementation of the modular arrangement of FIG. 8.

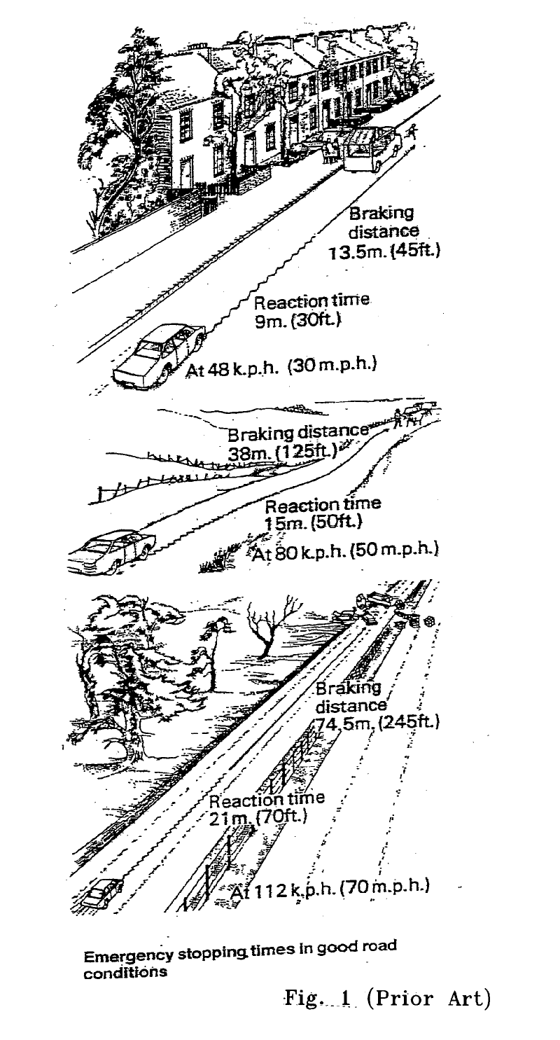

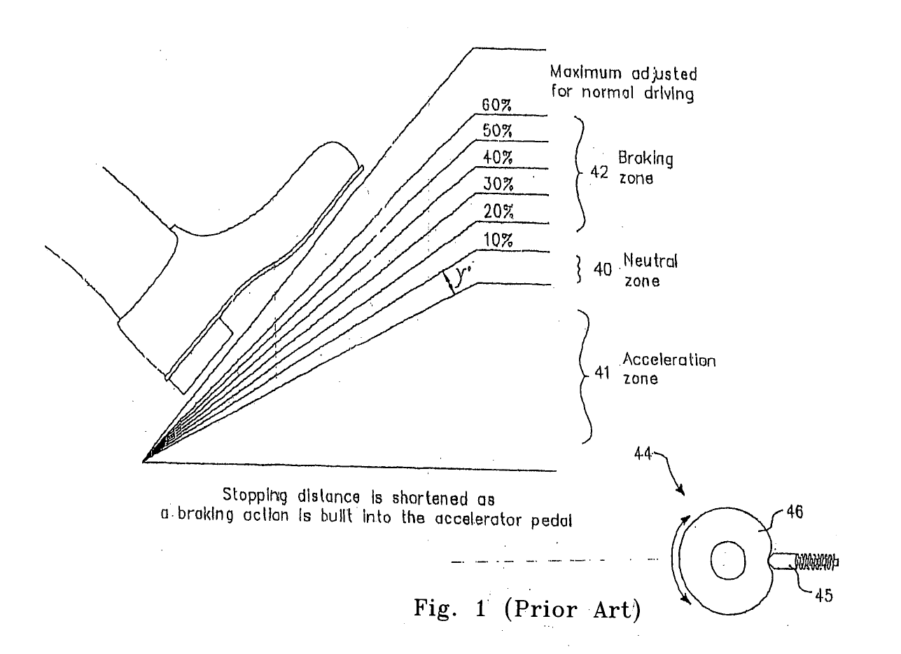

### DETAILED DESCRIPTION OF PREFERRED EMBODIMENTS

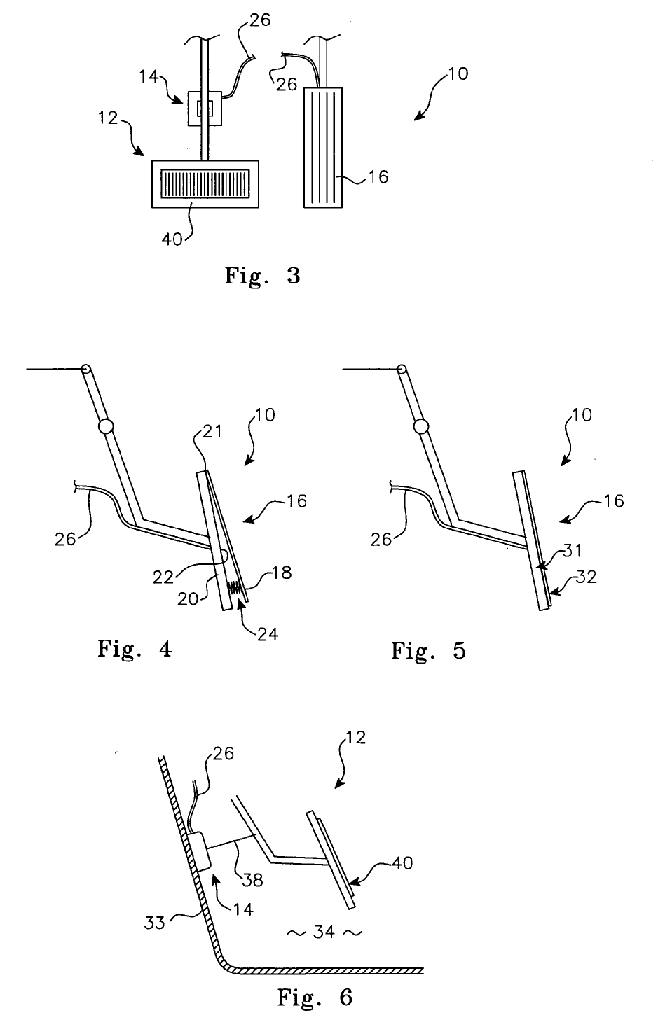

With reference to FIG. 3, the controls of a typical motor vehicle include an accelerator pedal 10 and a brake pedal 12. Although a vehicle equipped with a manually operated gear train may be additionally equipped with a clutch pedal, the present invention is concerned only with the two pedals, accelerator pedal 10 and brake pedal 12.

In practise embodiments of the present invention are suited to conventional automatic transmission equipped vehicles which have only an accelerator pedal and a brake pedal and do not have a third clutch pedal to assist changing gears.

As also shown in FIG. 3, the brake pedal 12 according to the invention, is provided with a control module 14, the function of which will be explained in more detail below. As best seen in FIGS. 3 and 4, the accelerator pedal 10 is provided with a secondary reaction surface 16.

Secondary reaction surface 16 in a first preferred embodiment shown in FIG. 4, comprises an auxiliary pedal 18, attached to a standard accelerator pedal 20 by a hinge 21, and covers at least a portion of the accelerator pedal 20. In this instance, the auxiliary pedal 18 is arranged so it can be depressed against a spring 24 a certain amount relative to the surface 22 of accelerator pedal 20, without inducing movement in accelerator pedal 20. When pressure is applied by the foot of a driver (not shown) past this point, the pressure applied is transmitted to the accelerator pedal 20, causing it to depress and urge the vehicle into motion in the usual way.

Auxiliary pedal 18 is thus arranged to move between a first deactivated state shown in FIG. 4, (when there is a maximum possible movement between the auxiliary pedal 18 and the surface 22 of pedal 20), and the fully activated state at the point where further application of pressure will induce movement in accelerator pedal 20. This movement between the deactivated state and the fully activated state is monitored by a sensor in this instance implemented in the form of a potentiometer 5A and relayed by lead 26 to control module 14 as force data.

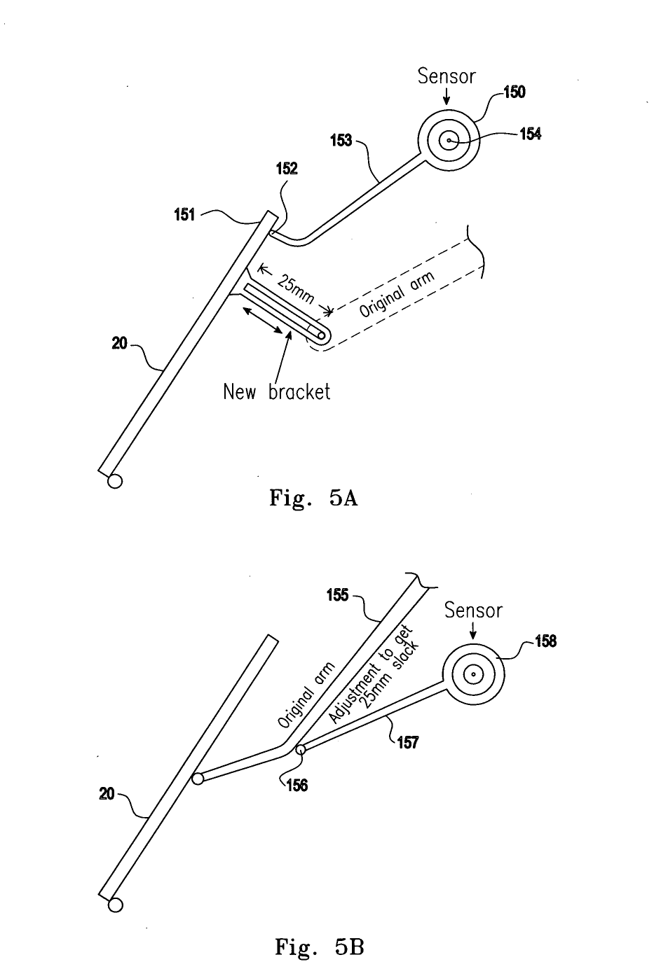

With reference now to FIG. 5, in a second preferred embodiment of a secondary reaction surface 31, accelerator pedal 20 has attached to its surface a pressure sensitive mat 32. Pressure sensitive mat 32 monitors, for example via a load cell (not shown), pressures applied to secondary reaction surface of mat 32 between a minimum and that pressure required to depress the accelerator pedal to the point at which engine rpm is increased and the vehicle urged into motion.

It will be understood, that in each of the embodiments, the pressure which needs to be applied either to the auxiliary pedal 18 or to pressure sensitive mat 32 to operate the system from a deactivated state to a fully activated state, must be less than the pressure required to depress the accelerator pedal. Preferably, the difference in pressures is such that there is a noticeable neutral feel zone perceptible to a driver. In a preferred form this is implemented by way of a mechanical detent (refer inset in FIG. 2). Also in a preferred form a switch is activated in this zone causing illumination of “coasting” light on the dashboard of the vehicle.

In each of the preferred embodiments, either the sensor of auxiliary pedal 18, or the load cell of pressure sensitive mat 32, is in electronic communication with control module 14 via lead 26. As best seen in FIG. 6, control module 14 is mounted rearward of arm 32 of brake pedal 12, either on the inside of the firewall 33 or foot well 34 where space permits, or in the engine bay on the outside of firewall 33. Control module 14 includes control and logic circuitry and a servomotor (not shown). The servomotor may take the form of a linear or rotary actuator which acts on a coupling 38 between the control module 14 and brake pedal arm 32. Coupling 38 is flexible, preferably a cable, so that the brake pedal 12 may be activated manually by pressure from the driver's foot regardless of the state of the actuator of control module 14.

In response to signals received from the sensor of auxiliary pedal 18 or the load cell of pressure sensitive mat 32 mounted at the accelerator pedal 10, the servomotor acts to vary the depression of brake pedal 12 from its first deactivated state as shown in FIG. 6, to a maximum activated state, that is the state of depression commensurate with at least a percentage of maximum available braking force.

### Alternative Arrangements for Secondary Reaction Surface

With reference to FIGS. 5A and 5B there are illustrated alternative arrangements wherein the secondary reaction surface takes the form of a guide arm mechanically associated with a pivot which operates a sensor 150 preferably in the form of an angle transducer.

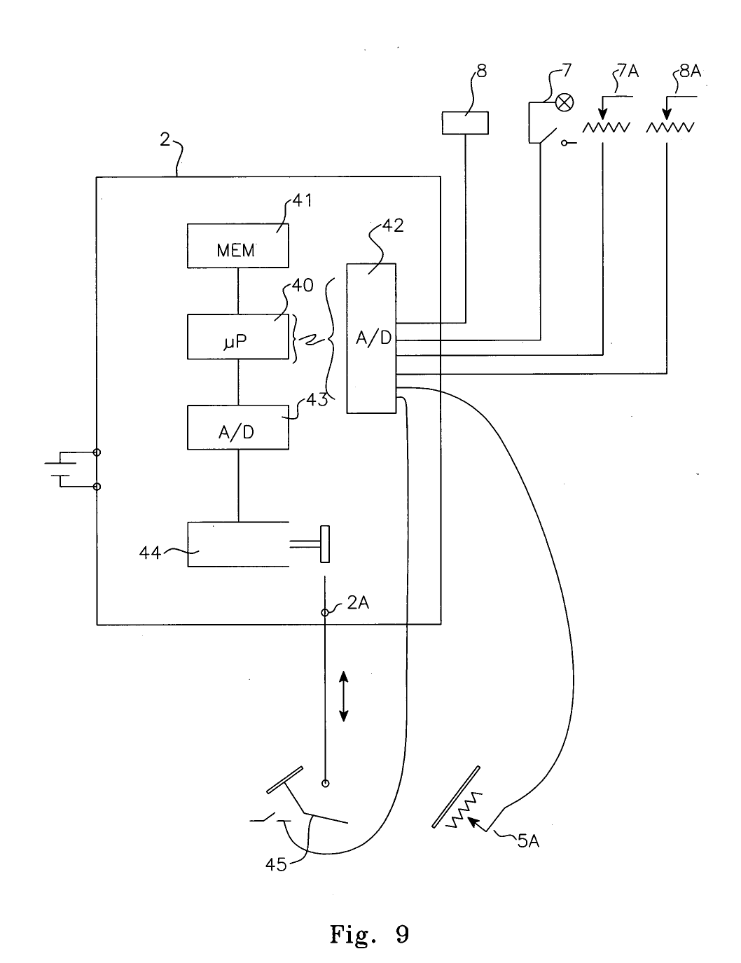

With reference to FIG. 5A operation is such that depression of accelerator pedal 20 causes a top portion 151 of accelerator pedal 20 to press against a secondary reaction surface in the form of pivot arm extension surface 152 thereby to cause rotation of sensor arm 153 about pivot 154 which causes operation of an angle sensor (not shown, but which can be of the form as illustrated) as potentiometer 5A in FIG. 9 thereby to impart a signal proportional to the angular position of pivot arm 153. This angular information is utilised by the control system in the manner previously described.

With reference to FIG. 5B accelerator pedal 20 operates against arm 155 which, in turn, operates against secondary reaction surface 156 located on an extended portion of pivot arm 157 of angular sensor 158. Operation of the accelerator pedal 20 causes rotation of pivot arm 157 thereby to vary the angular position of angular sensor 158 thereby to impart an angle signal for use by the control system in the manner previously described.

It will be observed that in this particular arrangement of FIG. 5A and FIG. 5B the secondary reaction surface is located on an opposite side of pedal 20 to that of previous embodiments but nonetheless acts as a secondary reaction surface for the purpose of acting as a mechanical communicator of position of or force applied to accelerator pedal 20.

Referring again to FIG. 6, brake pedal 12 is provided on its surface with a secondary reaction surface, in this instance a pressure sensitive pad 40, incorporating a switch (not shown). Immediately pressure is applied to the brake pedal via pad 40 by the foot of a driver, the switch disables control module 14, so that manual control of braking action is returned to the driver.

Mounted within easy reach of the driver, preferably on the dashboard or, in a system fitted to a vehicle as original equipment, incorporated in the wiper or indicator stalks, is an enable control 7 for control module 14. The control can comprise an illuminated button which illuminates when and only when the system is on. By means of this control, a driver may select to operate the vehicle's braking system via the accelerator, or to retain normal manual control of the brake pedal.

Also mounted within easy reach of the driver are two dial controls, by which operating characteristics of the accelerator braking system of the invention may be modified to suit the preferences of a driver. The first of these controls 3 allows a driver to vary the rate at which the servo motor of the control module 14 responds to input signals received from the accelerator pedal's secondary reaction surface. The second control 4 allows the driver to select the percentage of the maximum available braking force of the vehicle as the maximum to be applied by the control module 14.

Preferably, the system is further provided with an indicator light 8 mounted in view of the driver which indicates when the secondary reaction surface and the accelerator pedal are in the neutral feel zone, that is to say, when a moving vehicle is coasting, with no acceleration applied to the engine or any retarding force applied by the brakes.

### In Use

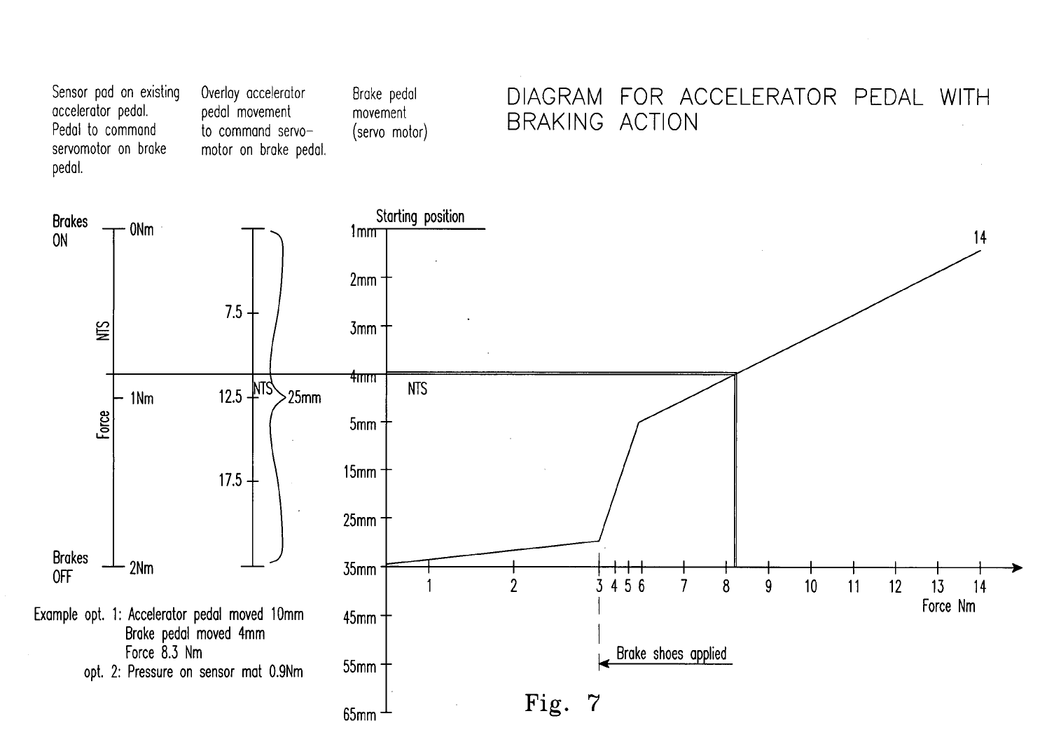

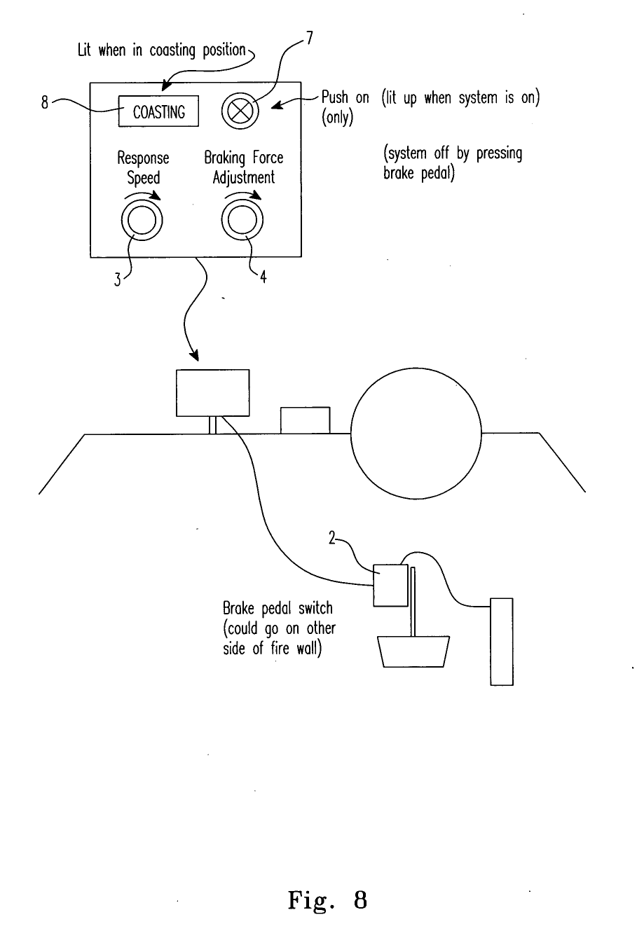

FIG. 7 shows graphically an example of the interaction of either, pressure applied to the pressure sensitive mat 32, or the movement of auxiliary pedal 18, with the operation of the vehicle's brakes.

In this example, at vehicle start up, with the accelerator braking system of the invention enabled, the control module 14 holds the brake pedal 12 in a depressed state to exert a braking force of 14 Nm (the maximum braking force selected by the driver). At this point, the auxiliary pedal 18 has not moved relative to the surface 22 accelerator pedal 20. In the case of the pressure sensitive mat 32, its load cell reads a minimum of zero Nm.

It can be seen from the graph that as pressure is applied to the secondary reaction surface of the accelerator pedal braking force decreases under the programmed control of the control module 14. Thus in the case of the auxiliary pedal 18, when, in this example, it has moved its full travel of approximately 25 mm, the brakes are fully off. This is equivalent to an increase in pressure on the pressure sensitive mat 32 from the initial reading of zero Nm to two Nm. In the example of FIG. 7, a movement of 10 mm of the auxiliary pedal 18, is translated by the control module 14 servo motor as 25 mm of releasing movement of the brake pedal from its maximum braking state, with a concomitant reduction in the braking force to 8.3 Nm.

Referring still to FIG. 7, when the vehicle is in motion and the accelerator braking system is enabled, driver may remove pressure on the secondary reaction surface (and thus on the accelerator pedal) to the point where the accelerator pedal is fully retracted from its depressed state. Further reduction of pressure then begins to reduce the depression of auxiliary pedal 18 from its maximum deflection of 25 mm (or the reduction of pressure on pressure sensitive mat 32 from 2 Nm). This causes the control module to gradually depress the brake pedal and apply a corresponding proportion of the maximum set braking force, bringing the vehicle to a braked standstill.

It will be clear that a sudden release of any pressure on the accelerator pedal and the secondary reaction surface will bring the maximum set braking force into play within the adjustable reaction time of the control module 14 and its actuator. This reaction time will be significantly shorter than the time it takes a driver to bring his leg and foot from the accelerator position to the brake pedal and depressing that pedal. Thus in an emergency, the initiation of considerable braking force can be applied more quickly, giving the driver time to then take over and apply manually (if required) the full braking force available from the vehicle's braking system.

The advantage of the present system in a stop/start traffic situation, is that by simply manipulating the accelerator pedal, a driver may alternatively bring the vehicle into motion and to a braked standstill. This is particularly advantageous in an automatic vehicle in which typically creep, even with the accelerator pedal completely released, forces a driver to manually apply the brakes each time the vehicle needs to be brought to a standstill.

### “Factory Fit” Embodiment:

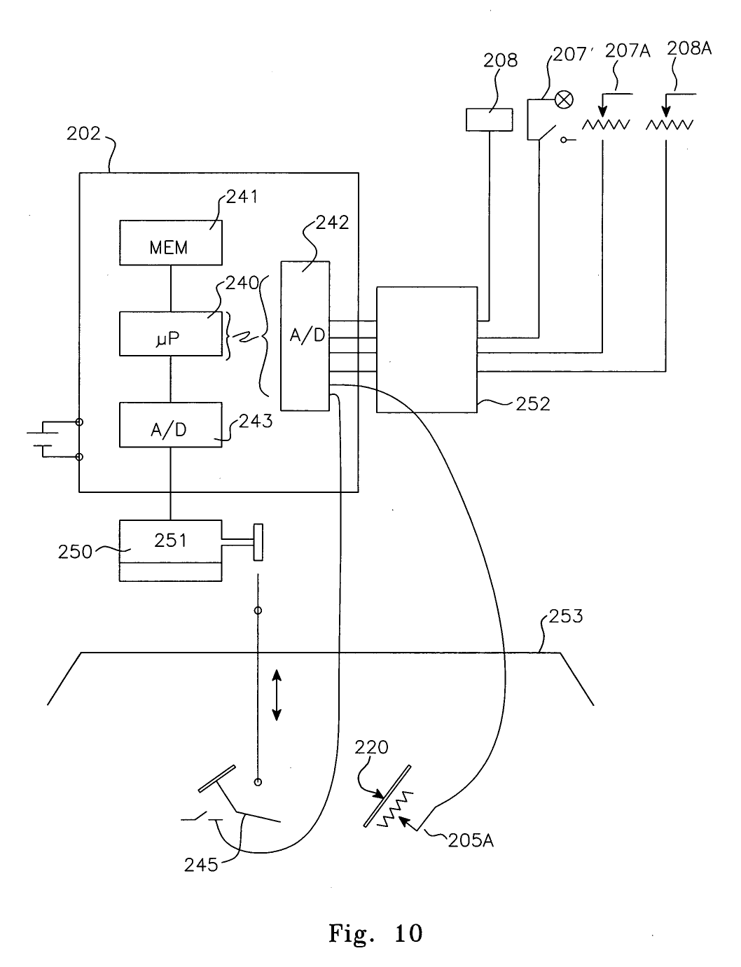

With reference to FIG. 10 there is illustrated a further variation to the arrangement illustrated with respect to FIG. 9 wherein advantage is taken of the digital electronic capability now pre-installed in vehicles at the factory.

With reference to FIG. 10 like components are numbered as for earlier embodiments except in the 200 series so, for example, dashboard mounted indicator light 8 becomes dash board mounted indicator light 208.

In this instance the majority of the functions of the control module previously described are incorporated into the vehicle's “black box” 202. That is to say most vehicles these days incorporate a vehicle control system or engine management system which includes a microprocessor 240 memory 241 and A/D converters 243, 242. In particular accelerator pedal 220 has its position sensed by a potentiometer arrangement 205A or equivalent whereby a signal proportional to accelerator pedal position is passed either directly as a digital signal or via analogue to digital converter 242 to microprocessor 240 within the vehicle electronic control module 202.

The vehicle electronic control module 202 controls many of the functions of the vehicle based on data it receives from various sensors including the accelerator position sensor just described. Most vehicles also include a master cylinder (which can be combined with a vacuum assist arrangement). The master cylinder 250 is mechanically linked to the brake pedal arm 245. A sensing arrangement 251 communicates brake fluid pressure data via analogue to digital converter 243 to microprocessor 240. In this embodiment an auxiliary control module 252 is in electronic communication with the vehicle control module 202 and also with ancillary components of the braking system of this embodiment including the sensor light 208 and other dashboard mounted components as illustrated in FIG. 10.

With this fully electronic “factory fit” arrangement there is no need to install any components on the driver's side of fire wall 253 of the vehicle. In this arrangement advantage is taken of the existing sensing arrangements and data already supplied to the vehicle electronic controller 202.

In a particular form the microprocessor 240 can be programmed to include a modified characteristic as compared with the accelerator/ braking profile illustrated in FIG. 7. That is to say in a “hill assist” mode where the vehicle is caused to brake on a sloping surface the “neutral zone” behaviour characteristic is by-passed with the vehicle proceeding from braking mode direct to powered mode so that there is no roll back of the vehicle on the sloping surface.

The above describes only some embodiments of the present invention and modifications, obvious to those skilled in the art, can be made thereto without departing from the scope of the present invention.

1. An accelerator braking system for a vehicle; said braking system reactive to forces applied to a secondary reaction surface of an accelerator pedal of said vehicle; said system characterized by a transmission to a control module of data corresponding to said forces applied to said secondary reaction surface wherein braking force is gradually increased and decreased by operation of the accelerator pedal; said control module further including a servomotor installed rearward of said brake pedal and operatively coupled to said brake pedal; said servomotor adapted to exert a pulling force on said brake pedal in order to effect increase of braking force.

2. The accelerator braking system of claim 1 wherein said data comprises force data or angle data.

3. The system of claim 1 wherein said control module includes a modified control characteristic which is applied when said vehicle is on a slope.

4. The system of claim 3 wherein said modified control characteristic operates in a “hill assist” mode whereby when said vehicle is caused to brake on a sloping surface a “neutral zone” behaviour characteristic is by-passed with the vehicle proceeding from braking mode direct to powered mode so that there is no roll back of the vehicle on the sloping surface as the vehicle accelerates from rest.

5. The system of claim 1 wherein said servomotor is connected to a portion of a pedal arm of said brake pedal by means of a flexible coupling.

6. The system of claim 1 wherein a secondary reaction surface comprises a hinged auxiliary pedal attached to said accelerator pedal; said hinged auxiliary pedal arranged for movement from a first deactivate state to a second fully activated state by pressure applied by a foot of a driver.

7. The system of claim 6 wherein said hinged auxiliary pedal includes a sensor in electronic communication with said control module.

8. The system of claim 7 wherein, in said fully activated state, additional pressure applied by said foot of said driver is transferred to said accelerator pedal so as to urge said accelerator pedal into an activated position.

9. The system of claim 6 wherein pressure applied by said foot of a driver to urge said secondary reaction surface from said deactivated state to said fully activated state is less than pressure required to urge said accelerator pedal from a deactivated state into a said activated position.

10. The system of claim 8 wherein transition from said fully activated state of said secondary reaction surface to a said activated position of said accelerator pedal includes a neutral feel zone perceptible to said driver.

11. The system of claim 10 wherein an indicator light mounted in view of a said driver of said vehicle is activated when pressure applied to said accelerator pedal is in said neutral feel zone.

12. The system of claim 6 wherein a transition from a said inactive state to a said fully activated state of said secondary reaction surface, is accompanied by a transition of said braking system from at least a percentage of full braking force to a zero braking force.

13. The system of claim 1 wherein said accelerator braking system is enabled by a suitably mounted enable switch within reach of a driver of said vehicle.

14. The system of claim 13 wherein said enable switch is illuminated when and only when the system is enabled.

15. The system of claim 1 wherein said brake pedal is provided with a secondary reaction surface; said secondary reaction surface comprising a pressure sensitive pad incorporating a disable switch, whereby pressure applied to said secondary reaction surface operates said switch to deactivate said control module.

16. The system of claim 14 wherein a range of said braking force between said zero braking force and said at least a percentage of full braking force (up to 100% of braking force) is adjustable from a dial control mounted within reach of a said driver of said vehicle.

17. The system of claim 12 wherein rate of response of said control module to said transmission of force data between said zero braking force and said at least a percentage of full braking force is adjustable from a dial control mounted within reach of a said driver of said vehicle.

18. The system of any one of claim 1 wherein said system is turned off when a foot is placed on said brake pedal.

19. The system of claim 1 wherein an “on” switch is available to switch the system on.

20. The system of claim 19 wherein said switch is illuminated when said system is on.

21. The system of claim 10 wherein a “coasting light” is illuminated when said accelerator pedal is in said neutral feel zone.

22-78. (canceled)
